(19) United States
(12) Patent Application Publication
(10) Pub. No.: US 2022/0007662 A1
(43) Pub. Date: Jan. 13, 2022

(54) Smoking Oven

(71) Applicant: Zhejiang Fudeer Electric Appliance Co., Ltd., Taizhou (CN)

(72) Inventors: Junhua Jiang, Taizhou (CN); Meide Jiang, Taizhou (CN)

(21) Appl. No.: 17/037,951

(22) Filed: Sep. 30, 2020

(30) Foreign Application Priority Data
Jul. 7, 2020 (CN) 202021319690.4
Jul. 7, 2020 (CN) 202021321568.0

(51) Int. Cl. A23B 4/052; A47J 37/06

(52) U.S. Cl. CPC A23B 4/052; A23V 2002/00; A47J 37/0623

(57) ABSTRACT

A smoking oven is disclosed in the present application. The smoking oven includes a case body provided with a smoking cavity therein; a heating device provided in the smoking cavity; and a smoking box provided in the smoking cavity and positioned over the heating device. A through hole is provided on a side wall of the case body, so that the smoking box can be conveniently removed out of or installed into the smoking cavity via the through hole. Replacing the smoking box via the through hole facilitates the use of the smoking oven.

### CROSS REFERENCE TO RELATED APPLICATIONS

The present application claims the priority benefit of CN202021319690.4 filed on Jul. 7, 2020 and CN202021321568.0 filed on Jul. 7, 2020. The entirety of each of the above-mentioned patent applications is incorporated herein by reference and made a part of this specification

### TECHNICAL FIELD

This application relates to the field of a roast appliance, and more particularly to a smoking oven.

### BACKGROUND

A smoking oven is an appliance used for making a wide variety of smoked flavor foods. Generally, a smoking box is provided in a smoking oven for containing a wide range of smoking materials. The smoking materials usually include woods for smoking, rice bran, tea leaves, dried orange peel, or the like.

When the smoking materials contained in a smoking oven is used off, they have to be replenished by opening the door of the smoking oven, removing the smoking box, supplementing smoking materials, and returning the smoking box into the smoking oven. However, a large amount of smoke will escape from the smoking oven during the replenishment, which is troublesome and entails an improvement.

### BRIEF SUMMARY

In view of the above deficiency, a smoking oven is provided in this application, which can prevent the escaping of a large amount of smoke from the smoking oven during replenishing smoking materials.

In one embodiment, a smoking oven is provided, including a case body provided with a smoking cavity therein; a heating device provided in the smoking cavity; and a smoking box provided in the smoking cavity and positioned over the heating device. A through hole is provided on a side wall of the case body, so that the smoking box can be conveniently removed out of or installed into the smoking cavity via the through hole.

In one embodiment, the size of the through hole is slightly larger than that of the smoking box. When the smoking material needs to be replenished, the used smoking box can be withdrawn out of the through hole, and a smoking box charged with fresh smoking materials can be inserted into the smoking box via the through hole. Compared with the manner of replacing the smoking box by opening the door of a smoking oven, the above way of replenishing the smoking materials according to the present application reduces the escaping of smoke, while decreasing the heat loss and waste due to lowered temperature caused by opening the door of the oven.

Optionally, a first bump can be provided on the side wall of the smoking box, so that the first bump can abut against the inner wall of the through hole after installing the smoking box in the smoking cavity, so as to produce a gap between the through hole and the side wall of the smoking box.

After installing the smoking box into the smoking cavity, due to the first bump abutting against the inner wall of the through hole, oxygen in the ambient air can be timely supplemented into the smoking cavity via the gap when the smoking material is burned to produce smoke, so as to provide oxygen needed for the burning of the smoking materials, producing a more stable smoke from the smoking material for smoke.

Optionally, a support plate can be provided in the case body, and positioned in the smoking cavity. The support plate is positioned over the heating device and under the smoking box, supporting the smoking box and providing a sliding guide for withdrawing or installing the smoking box.

In the above technical solution, the support plate can provide further support for the sliding of the smoking materials, providing a more stable sliding for the latter. In addition, the support plate separates the heating device from the smoking box, so as to prevent the temperature of the smoking materials in the smoking box from becoming too high, avoiding over burning of the smoking materials and providing a more stable burning for the latter.

Optionally, the support plate includes a plate body fixed on an inner wall of the case body and a plurality of abutting portions provided on an upper end face of the plate body. An upper end of the abutting portion is configured to abut against a lower end face of the smoking box.

In the above technical solution, the upper end of the abutting portion is higher than the upper end face of the support plate, so as to reduce the contact area of the smoking box with the support plate and further separate the heating device from the smoking box, which avoids the over burning of the smoking materials and providing a more stable burning for the latter.

Optionally, two guide plates can be fixed on the support plate, and positioned on two sides of the smoking box along a sliding direction thereof.

In the above technical solution, the guide plate provides a guide for the sliding of the smoking box on the support plate, which reduces the occurrence of shifting or tipping over of the smoking box when sliding into or out of the smoking cavity, and makes it more convenient to manipulate the movement of the smoking box.

Optionally, a stop piece can be fixed on the guide plate, and positioned on an end face of the guide plate close to the smoking box. The stop piece is configured for limiting a maximum insertion distance of the smoking box into the through hole.

In the above technical solution, the insertion distance of the smoking box can be limited by the stop piece so as to avoid over insertion of the smoking box.

Optionally, a resilient protrusion can be provided on the guide plate, and positioned on an end face of the guide plate close to the smoking box. A recess is provided on an outer wall of the smoking box for the resilient protrusion to snap in.

In the above technical solution, the providing of the resilient protrusion and the recess enables of the positioning of the smoking box in the smoking oven, so that the smoking box can be positioned just over the heating device, providing a more stable smoking effect for the smoking box.

Optionally, a support piece is provided on the heating device, and positioned between the support plate and the heating device. An upper end of the support piece abuts against a lower end face of the support plate.

In the above technical solution, the support piece can support the support plate, preventing the latter from deformation and providing a more stable overall structure. Meanwhile, the support piece separates the heating device from the support plate, which decreases the direct contact area of the heating device with the support plate, reducing heat transfer therebetween and in turn the occurrence of over burning of the smoking materials.

Optionally, the smoking box includes a box body and a box cover. A receiving trough is provided on the box body, and provided with at least two receiving regions, in which distances from the inner walls at the bottom of the at least two receiving regions to the bottom of the box body are different from each other. The box cover is configured for covering the receiving trough, with a plurality of smoke holes being provided thereon.

In the above technical solution, the distances from the inner walls at the bottom of individual receiving regions to the bottom of the box body are different from each other, so that the smoking materials at the bottoms of the individual receiving regions are subjected to different heating temperatures. That is, a smoking material at the bottom of a receiving region close to the bottom of the box body is subjected to a higher temperature and generates smoke first, and a smoking material at the bottom of a receiving region far away from the bottom of the box body is subjected to a lower temperature and generates smoke later. Therefore, the occurrence of generating a large amount of smoke in individual receiving regions at the same time can be avoided, and a consistent smoking in the smoking box can be guaranteed during heating, achieving an effect of slowing the consumption rate of the smoking materials.

Optionally, the box body includes a plurality of separators positioned in the receiving trough. Receiving regions are formed by combining the separators with inner walls of the receiving trough.

In the above technical solution, the separators separate different receiving regions from each other, reducing the interference of the smoking materials in individual receiving regions with each other and providing a more stable consumption of the smoking materials in the smoking box.

Optionally, the separator includes a side plate fixed on the box body and a bottom plate connected to the side plate. The bottom plate is horizontally fixed at a lower end of the side wall. The distances from the bottom plates of the plurality of the separators to the bottom of the box body are different from each other.

In the above technical solution, due to different distances from the bottom plates to the bottom of the box body, the smoking materials on the bottom plates can be subjected to different heating temperatures, achieving a slowed consumption rate of the smoking materials.

Optionally, installing plates are fixed at the inner side wall of the side wall close to the receiving cavity, with two or more installing holes being provided on each of the installing plates. A locking piece is provided on the box body, and extends through the installing hole for fixing the separator onto the box body.

In the above technical solution, the separator is installed via the locking piece, so as to facilitate the forming of individual receiving regions of the smoking box and in turn the production of the smoking box.

Optionally, a positioning plate is provided at one side of the box cover, and bent upward to form a bending portion. Correspondingly, a positioning hole is provided on the box body for the positioning plate to be passed through and positioned in place, which has a width along the vertical direction smaller than a width of the bending portion along the vertical direction.

In the above technical solution, the box cover is positioned by passing the bending portion of the positioning plate through the positioning hole, and covered on the box body under gravity. In this case, the bending portion of the positioning plate is in the vertical direction, so that the positioning plate will not be prone to sliding off the positioning hole since the width of the positioning hole in the vertical direction is smaller than the width of the bending portion in the vertical direction, facilitating the covering operation between the box cover and the box body.

Optionally, a protruded block is fixed on an end of the box cover away from the positioning plate.

In the above technical solution, for opening the box cover, the protruded block can be turned to turn over the box cover, facilitating the opening of the box cover.

Optionally, a handle is provided on the box body, and positioned at an end of the box body facing the outside of the case body.

In the above technical solution, the smoking box can be driven to move by the handle, facilitating the movement of the smoking box.

Optionally, the smoke box further includes a heat insulation member provided on the box body and positioned between the box body and the handle, so that the handle is provided on the box body via the heat insulation member. A heat insulation cavity is provided in the heat insulation member.

In the above technical solution, heat can be insulated by the heat insulation cavity to reduce heat transfer, protecting a hand from being burned by the handle.

Optionally, the heat insulation member includes a first cover plate provided on the box body and a second cover plate provided on the first cover plate, which combined with each other to form the heat insulation cavity.

In the above technical solution, the heat insulation cavity can be formed by combining the first cover plate and the second cover plate, making the forming of the heat insulation cavity more convenient.

Optionally, an air hole is provided on an end face of the second cover plate away from the box body for communicating the heat insulation cavity with an outer environment.

In the above technical solution, the air hole provides an air exchange between the hot air in the insulation cavity and the ambient air to enhance the heat dissipation effect of the heat insulation member and reduce heat transfer to the handle.

Optionally, an air baffle is fixed at an end face of the second cover plate away from the box body, and positioned at a side of the air hole facing the handle.

In the above technical solution, the air hole can be shielded by the air baffle, decreasing the flow of the hot air in the heat insulation cavity toward the handle and preventing a hand from being burned by the hot air from the heat insulation cavity when pulling the handle.

Optionally, a second bump is provided on an outer side wall of the heat insulation member, which is configured to abut against the inner wall of the through hole after installing the smoking box into the smoking cavity to produce a gap between the through hole and a side wall of the smoking box.

In the above technical solution, the heat insulation member mainly serves the function of reducing the heat transferred to the handle. Providing the second bump on the heat insulation member enlarges the contact area of the heat insulation member with the ambient air, so that the ambient air supplemented into the smoking cavity via the gap can lower the temperature of the heat insulation member to some extent, providing a better heat dissipation effect for the heat insulation member.

In summary, the present application can achieve at least one of the following beneficial technical effects.

(1) Heat loss and waste caused by lowered temperature in the oven caused by opening the door of the oven can be prevented by providing a through hole to reduce the escaping of smoke.

(2) The sliding of the smoking materials becomes more stable due to the providing of the support plate, and an over burning of the smoking materials can be avoided due to the separation of the heating device from the smoking box by the support plate, providing a more stable consumption of the smoking materials.

(3) The occurrence of generating a large amount of smoke in individual receiving regions at the same time can be avoided by providing different distances between the bottoms of at least two receiving regions and the bottom of the box body, which achieves a continuous smoking from the smoking box during the whole process of heating and a slowed consumption of the smoking materials.

### BRIEF DESCRIPTION OF DRAWINGS

FIG. 1 is an overall schematic diagram of a smoking oven according to one embodiment;

FIG. 2 is a local structural schematic diagram according to one embodiment;

FIG. 3 is a local explosion schematic diagram of a support plate and a smoking box according to one embodiment;

FIG. 4 is a local sectional schematic diagram of a heat insulation member according to one embodiment;

FIG. 5 is an explosion schematic diagram of a heat insulation member according to one embodiment;

FIG. 6 is a local explosion schematic diagram of a smoking box according to one embodiment; and

FIG. 7 is a local sectional view of a smoking box according to one embodiment.

### DETAILED DESCRIPTION

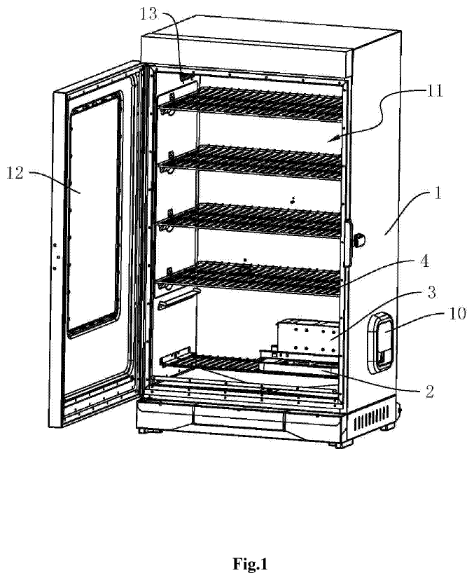

This application will be further explained below in detail as follow in connection with FIGS. 1-7.

Referring to FIG. 1, a smoking oven is provided, including a case body 1, which includes a smoking cavity 11 provided therein and a door 12 provided thereon. In one embodiment, the door 12 is hinged with the case body 1 for opening or closing the smoking cavity 11 by rotating. An air vent 13 is provided on the case body 1, close to the top of the case body 1. The air vent 13 communicates the smoking cavity 11 with an outer environment, so as to ensure an air ventilation and oxygen replenishment into the smoking cavity from the outside during smoking. A heating device 2, a smoking box 3 and a plurality of material racks 4 are provided in the smoking cavity 11. The plurality of material racks 4 are positioned along a vertical direction. In some embodiments, the plurality of material racks 4 are mesh plates for placing food materials thereon. The heating device 2 is configured to heat and burn a smoking material in the smoking box 3 to generate smoke which smokes the food materials in the smoking cavity 11.

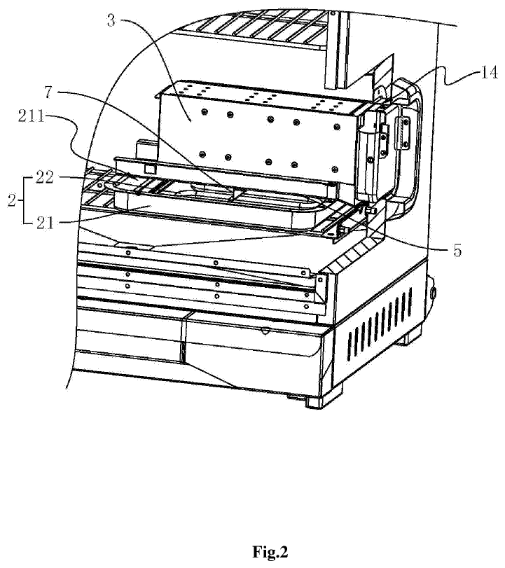

Referring to FIG. 2, the heating device 2 includes a seat 21 and heating tube 22. The seat 21 is fixed within the case body 1, and provided with a receiving groove 211 on an upper end face thereof. The heating tube 22 is positioned in the receiving groove 211 for generating heat when being energized.

The smoking box 3 is positioned over the heating device 2. A through hole 14 is provided on a side wall of the case body 1 for communicating the smoking cavity 11 with an outer environment. In some embodiments, the smoking box 3 is slidably connected in the through hole 14 along a horizontal direction, so that the smoking box 3 can be withdrawn from the smoking cavity 11 along the through hole 14 or installed into the smoking cavity 11 along the through hole 14, facilitating a convenient replacement thereof.

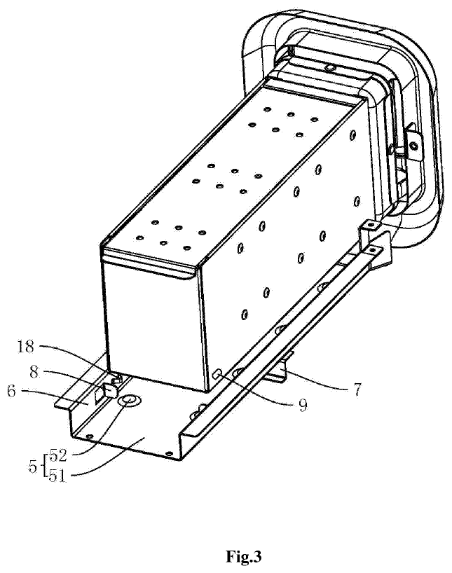

Referring to FIG. 2 and FIG. 3, a support plate 5 is further provided in the case body 1, which is positioned under the smoking box 3 and over the heating device 2. In some embodiments, the support plate 5 includes a plate body 51 fixed on an inner side wall of the case body 1, and a plurality of abutting portions 52 fixed on an upper end face of the plate body 51. In some embodiments, the abutting portion 52 can be block protrusion, conic protrusion, or hemispherical protrusion. Preferably, abutting portion 52 is a hemispherical protrusion.

Referring to FIG. 2 and FIG. 3, two guide plates 6 are further fixed on the support plate 5, and positioned on two sides of the smoking box 3 along a sliding direction thereof. A support piece 7 is further provided between the support plate 5 and the heating device 2, with a lower end fixed on the heating device 2 and an upper end abutting against a lower end face of the support plate 5 for supporting the support plate 5 to alleviate the deformation thereof.

When the smoking box 3 is sliding along the through hole 14, the guide plate 6 provides a guide for the sliding of the smoking box 3 on the support plate 5, preventing the smoking box 3 from shifting or turning over when being slid into or out of the smoking cavity 11. In addition, the upper end of the abutting portion 52 is configured to abut against the lower end face of the smoking box 3 for supporting the sliding of the smoking box 3, which reduces the contact area of the smoking box 3 with the support plate 5 and in turn a frictional force therebetween, so that the sliding of the smoking box 3 in the through hole 14 is more convenient. In addition, the heating device 2 is separated from the smoking box 3 by the support plate 5, so as to reduce the occurrence of excess temperature of the smoking materials in the smoking box 3 and in turn the occurrence of over burning of the smoking materials. Further, the upper end of the abutting portion 52 is higher than the upper end face of the support plate 5. When the abutting portion 52 is a hemispherical protrusion, it is in point contact with the smoking box 3, which reduces the contact area of the smoking box 3 with the support plate 5, and in turn decreases the heat transfer via direct contact, preventing the smoking box 3 from being over heated.

Referring to FIG. 3, a stop piece 8 is fixed on each of the guide plates 6, two of which positioned on two guide plates 6 are opposite to each other. The stop piece 8 is positioned on an end face of the guide plate 6 close to the smoking box 3, away from the through hole 14. A resilient protrusion 18 is provided on both of the two guide plates 6, which, in one embodiment, is a resilient piece fixed on the guide plate 6. The resilient protrusion 18 is positioned on an end face of the guide plate 6 close to the smoking box 3, and the resilient protrusions 18 on two guide plates 6 are provided opposite to each other. A recess 9 is provided on an outer wall of the smoking box 3, two of which are correspondingly positioned on two sides of the smoking box 3 along the sliding direction thereof. The position of the recess 9 corresponds to that of the resilient protrusion 18, so that the resilient protrusion 18 can be snapped into the recess 9 and positioned in place when the smoking box 3 is installed into the smoking cavity 11.

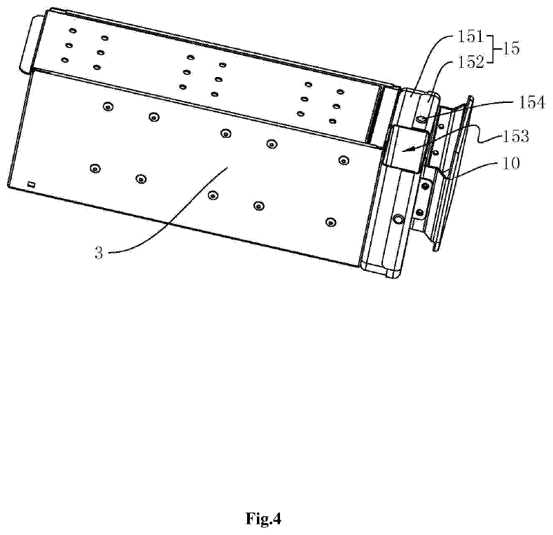

Referring to FIG. 4, a handle 10 is provided on an end of the smoking box 3 along a length direction thereof, and positioned on an end of the smoking box 3 facing the outside of the case body 1. A heat insulation member 15 is provided between the smoking box 3 and the handle 10, with a heat insulation cavity 153 being provided therein. The heat insulation member 15 includes a first cover plate 151 provided on the smoking box 3 and a second cover plate 152 provided on the first cover plate 151. A concave cavity is provided on the end faces of the first cover plate 151 and the second cover plate 152 opposite to each other, which abut against each other to form a heat insulation cavity 153. In particular, the abutting is achieved by inserting the first cover plate 151 into the concave cavity of the second cove plate 152. The handle 10 is fixedly connected to an end face of the second cover plate 152 away from the smoking box 3, and provided on the smoking box 3 by being installed on the heat insulation member 15.

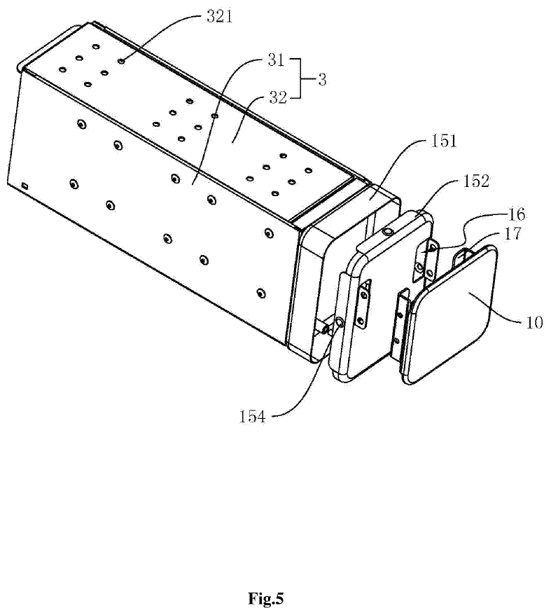

Referring to FIG. 4 and FIG. 5, a second bump 154 is further fixed on an outer side wall of the heat insulation member 15. In some embodiments, the second bump 154 is positioned on the second cover plate 154. The second bump 154 is a hemispherical protrusion, and 4 second bumps 154 are located on 4 side walls of the heat insulation member 15 in a circumferential direction, respectively. Alternatively, the second bump 154 can be fixed on an outer side wall of the smoking box 3.

The 4 second bumps 154 abut against corresponding inner walls of the through hole 14 after installing the smoking box 3 into the smoking cavity 11, so as to produce a gap in the through hole 14. When the smoking materials are burned to produce smoke, oxygen in the ambient air can be timely supplemented into the smoking cavity via the gap, so as to provide oxygen needed for the burning of the smoking materials.

In addition, the heat insulation member 15 mainly serves the function of reducing the heat transferred to the handle 10. Providing the second bump 154 on the heat insulation member 15 enlarges the contact area of the heat insulation member 15 with the ambient air, so that the ambient air supplemented into the smoking cavity 11 via the gap can lower the temperature of the heat insulation member 15 to some extent, providing a better heat dissipation effect for the heat insulation member 15.

Referring to FIG. 4 and FIG. 5, an air hole 16 is further provided on an end face of the second cover plate 152 away from the smoking box 3 for communicating the heat insulation cavity 153 with an outer environment. An air baffle 17 is fixed at an end face of the second cover plate 152 away from the smoking box 3, and positioned at a side of the air hole 16 facing the handle 10. The air baffle 17 is formed by a bent plate connected with the handle 10. A spacing of 1-2 mm is produced between the air baffle 17 and the opening of the air hole 16 after installing the handle 10 onto the second cover plate 152.

When heat is generated due to the burning of the smoking materials in the smoking box 3, hot air inside the heat insulation cavity 153 is timely exchanged with the ambient air to increase the heat dissipation effect of the heat insulation member 15 while reducing the heat delivered to the handle 10. The air baffle 17 can shield the air hole 16 along the air flow direction, so that the hot air in the heat insulation cavity 153 is laterally guided away along the gap between the air baffle 17 and the opening of the air hole 16, decreasing the amount of the hot air directly flowing toward the handle 10 from the heat insulation cavity 153 and avoiding the occurrence of skin burning caused by the hot air in the heat insulation cavity 153 when pulling the handle 10.

When inserting the smoking box 3 along the through hole 14, the sliding of the smoking box 3 is blocked by the stop piece 8 located on the sliding path of the smoking box 3, so as to limit the maximum insertion distance of the smoking box 3 into the through hole 14, preventing an excess insertion of the smoking box 3. When the smoking box 3 abuts against the stop piece 8, the resilient protrusion 18 is correspondingly snapped into the recess 9 and positioned in place, so that the smoking box 3 is positioned just over the heating device 2. In this way, the smoking box 3 can be steadily positioned via the positioning provided by the resilient protrusion 18 and the recess 9. When it needs to withdraw the smoking box 3, the smoking box 3 is pulled with great effort, so that the resilient protrusion 18 is deformed and pulled out of the recess 9, and the smoking box 3 can be removed along the through hole 14.

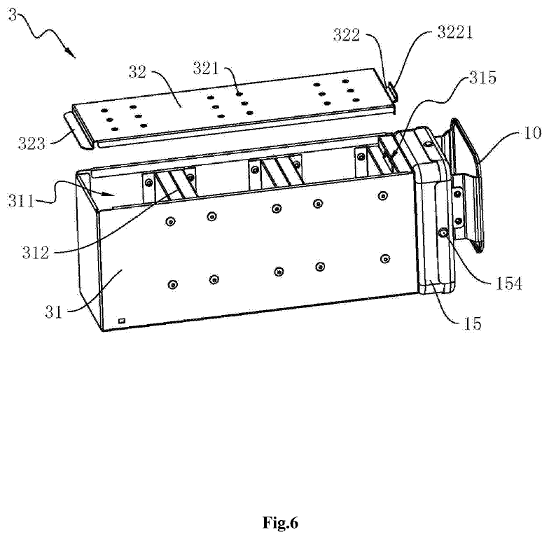

Referring to FIG. 5 and FIG. 6, the smoking box 3 includes a box body 31 and a box cover 32. A receiving trough 311 is provided on an upper end face of the box body 31. The box cover 32 is positioned above the box body 31 for covering the receiving trough 311, with a plurality of smoke holes 321 provided thereon. When the box cover 32 covers the receiving trough 311, the smoking holes 321 communicates the receiving cavity of the box body 31 with an environment outside the smoking box 3.

Referring to FIG. 5, a positioning plate 322 is fixed one side of the box cover 32, and positioned at an end of the box cover 32 along a length direction thereof. The positioning plate 322 is bent upward to form a bending portion 3221. A protruded block 323 is fixed on an end of the box cover 32 away from the positioning plate 322. A positioning hole 315 is provided on an end of the box body 31 close to the handle 10 and positioned corresponding to the bending portion 3221, having a width along the vertical direction smaller than a width of the bending portion 3221 along the vertical direction.

When the box cover needs to be installed on the box body 31, it is positioned by passing the bending portion 3221 of the positioning plate 322 through the positioning hole 315 and covers the box body 31 under the action of gravity. In this case, the bending portion 3221 of the positioning plate 322 is in the vertical direction, so that the positioning plate 322 is not prone to sliding off the positioning hole 315 since the width of the positioning hole 315 in the vertical direction is smaller than that of the bending portion 3221 in the vertical direction. When the box cover 32 needs to be opened, the protruded block 323 is manipulated to turn over the box cover 32, and the bending portion 3221 of the positioning plate 322 is removed out of the positioning hole 315, so that the residues of the smoking materials can be poured out of the box body 31.

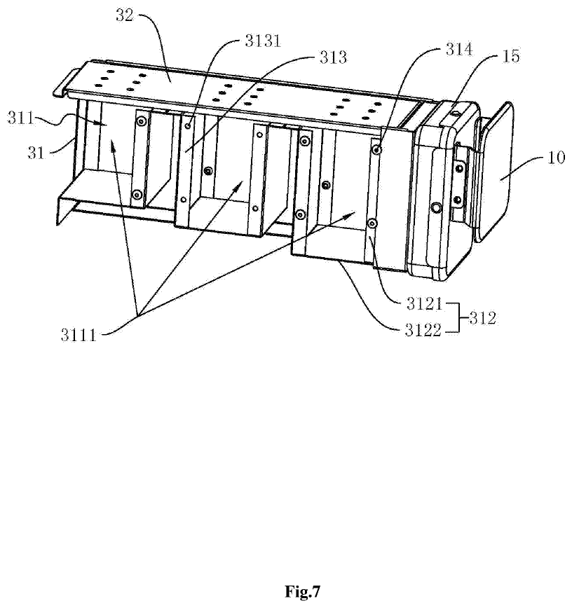

Referring to FIG. 6 and FIG. 7, the receiving trough 311 is provided with at least two receiving regions 3111, in which distances from the inner walls at the bottom of the at least two receiving regions 3111 to the bottom of the box body 31 are different from each other. The box body 31 further includes a plurality of separators 312 positioned in the receiving trough 311. The plurality of the separators 312 are arranged along the length direction of the box body 31, and the two ends of each separator 312 along the width direction of the box body 31 abuts against the inner side wall of the receiving trough 311 and are fixed therein. In some embodiments, three receiving regions 3111 are provided, each of which is formed by combining the separator 312 with the inner wall of the receiving trough 311.

Referring to FIG. 7, the separator 312 includes a side plate 3121 fixed on the box body 31 and a bottom plate 3122 connected to the side plate 3121. The bottom plate 3122 is fixed at the lower end of the side wall 3121. The distances from the bottom plates 3122 of the plurality of the separators 312 to the bottom of the box body 31 are different from each other. Individual receiving regions 3111 are separated by the separators 312 from each other, and the bottom of the receiving regions 3111 become an upper end face of the bottom plate 3122.

In some embodiments, each of the separators 312 of two receiving regions 311 close to the handle 10 has two vertical side plates 3121 connected with one bottom plate 3122, so that a receiving region 3111 is formed by combining the two side plates 3121, the bottom plate 3122, and the inner wall of the receiving trough 311 with each other. The rest one of the receiving region 3111 has one side plate 3121 and one bottom plate 3122. In particular, one end of the bottom plate 3122 is connected with an upper end of a corresponding side plate 3121, and the other end of the bottom plate 3122 abuts against the inner wall of the receiving trough 3111 away from the handle 10, so that they are combined with two inner walls of the receiving trough 311 along the width direction of the box body 31 to form this receiving region 3111.

Referring to FIG. 7, an installing plate 313 is fixed at an inner side wall of the side wall 3121 close to the receiving cavity, with two or more installing holes 3131 being provided on each of the installing plates 313. A locking piece 314 is provided on the box body 31, and extends through the installing hole 3131 and the box body 31 for fixing the separator 312 onto the fix body 31. In some embodiments, the locking piece 314 is a rivet. Alternatively, the lock piece 314 can be a screw, which can be passed through the installing hole 3131 and screwed with the box body 31 for fixation.

During the use of the smoking box 3, the distances from the inner walls at the bottom of individual receiving regions 3111 to the bottom of the box body 31 are different from each other, so that the smoking materials at the bottoms of the individual receiving regions 3111 are subjected to different heating temperatures. That is, a smoking material at the bottom of a receiving region 3111 close to the bottom of the box body 31 is subjected to a higher temperature and generates smoke first, and a smoking material at the bottom of a receiving region 3111 far away from the bottom of the box body is subjected to a lower temperature and generates smoke later. In addition, the separators 312 separate different receiving regions 3111 from each other, reducing the interference of the smoking materials in individual receiving regions 3111 with each other. Therefore, the occurrence of generating a large amount of smoke in individual receiving regions 3111 at the same time can be avoided, so that a consistent smoking in the smoking box 3 can be guaranteed during heating, achieving an effect of slowing the consumption rate of the smoking materials.

The working principle of the smoking oven according to one embodiment can be as follows.

When the smoking materials need to be replenished, the smoking box 3 can be pulled out of the case body 1 via the through hole 14, so that the box cover 32 can be opened to pour out the residues of the smoking materials. Then, the smoking materials in individual receiving regions 3111 in the box body 31 can be replenished, the box cover 32 can be covered on the box body 31, and the smoking box 3 recharged with smoking materials can be inserted into the smoking cavity 11 via the through hole 14. In particular, a plurality of smoking boxes 3 can be provided so that they can be interchangeably used, so as to reduce the waiting time for withdrawing and replenishing the smoking materials. Compared with the manner of opening an oven door 12 for replacing a smoking box 3, the manner for replacing the smoking box 3 according to the present application reduces the escaping of the smoke, facilitates the replenishment of smoking materials in the smoking box 3, and provides a better smoking for foods, while reducing heat loss and waste due to lowered temperature in the oven caused by opening the oven door 12.

The above embodiments are merely provided for explanation of this application, and do not limit the protection scope of this application. Those skilled in the art can make modifications without creative contribution to this embodiment after reading this specification, and it is protected by the patent law as long as it is within the scope of the claims of this application.

What is claimed is:

1. A smoking oven, comprising:
a case body provided with a smoking cavity therein;
a heating device provided in the smoking cavity; and
a smoking box provided in the smoking cavity and positioned over the heating device,
wherein a through hole is provided on a side wall of the case body, so that the smoking box can be conveniently removed out of or installed into the smoking cavity via the through hole.

2. The smoking oven according to claim 1, wherein a first bump is provided on a side wall of the smoking box, so that the first bump abuts against the inner wall of the through hole after installing the smoking box in the smoking cavity to produce a gap between the through hole and the side wall of the smoking box.

3. The smoking oven according to claim 1, wherein a support plate is provided in the case body, positioned in the smoking cavity, and located over the heating device and under the smoking box, and the support plate is configured for supporting the smoking box and providing a sliding guide for withdrawing or installing the smoking box.

4. The smoking oven according to claim 3, wherein the support plate includes a plate body fixed on an inner wall of the case body and a plurality of abutting portions provided on an upper end face of the plate body, and an upper end of the abutting portion is configured to abut against a lower end face of the smoking box.

5. The smoking oven according to claim 3, wherein two guide plates are fixed on the support plate, and positioned on two sides of the smoking box along a sliding direction thereof.

6. The smoking oven according to claim 5, wherein a stop piece is fixed on the guide plate, positioned on an end face of the guide plate close to the smoking box, and configured for limiting a maximum insertion distance of the smoking box into the through hole.

7. The smoking oven according to claim 5, wherein a resilient protrusion is provided on the guide plate and positioned on an end face of the guide plate close to the smoking box, and a recess is provided on an outer wall of the smoking box for the resilient protrusion to snap in.

8. The smoking oven according to claim 3, wherein a support piece is provided on the heating device and positioned between the support plate and the heating device, and an upper end of the support piece abuts against a lower end face of the support plate.

9. The smoking oven according to claim 1, wherein the smoking box includes a box body and a box cover, and a receiving trough is provided on the box body and provided with at least two receiving regions; the distances from the inner walls at the bottom of the at least two receiving regions to the bottom of the box body are different from each other; and the box cover is configured for covering the receiving trough, with a plurality of smoke holes being provided thereon.

10. The smoking oven according to claim 9, wherein the box body includes a plurality of separators positioned in the receiving trough, and a receiving region is formed by combining the separators with inner walls of the receiving trough.

11. The smoking oven according to claim 10, wherein the separator includes a side plate fixed on the box body and a bottom plate connected to the side plate, the bottom plate is horizontally fixed at a lower end of the side wall, and the distances from the bottom plates of the plurality of the separators to the bottom of the box body are different from each other.

12. The smoking oven according to claim 11, wherein installing plates are fixed at the inner side wall of the side wall close to the receiving cavity, with two or more installing holes being provided on each of the installing plates, and a locking piece is provided on the box body and extends through the installing hole for fixing the separator onto the box body.

13. The smoking oven according to claim 9, wherein a positioning plate is provided at one side of the box cover and bent upward to form a bending portion, a positioning hole is corresponding provided on the box body for the positioning plate to be passed through and positioned in place, and the positioning hole has a width along the vertical direction smaller than a width of the bending portion along the vertical direction.

14. The smoking oven according to claim 13, wherein a protruded block is fixed on an end of the box cover away from the positioning plate.

15. The smoking oven according to claim 9, wherein a handle is provided on the box body, and positioned at an end of the box body facing the outside of the case body.

16. The smoking oven according to claim 15, wherein the smoke box further includes a heat insulation member provided on the box body and positioned between the box body and the handle, so that the handle is provided on the box body via the heat insulation member; and a heat insulation cavity is provided in the heat insulation member.

17. The smoking oven according to claim 16, wherein the heat insulation member includes a first cover plate provided on the box body and a second cover plate provided on the first cover plate, and a heat insulation cavity is formed by combining the first cover plate and the second cover plate with each other.

18. The smoking oven according to claim 17, wherein an air hole is provided on an end face of the second cover plate away from the box body for communicating the heat insulation cavity with an outer environment.

19. The smoking oven according to claim 18, wherein an air baffle is further fixed at an end face of the second cover plate away from the box body, and positioned at a side of the air hole facing the handle.

20. The smoking oven according to claim 16, wherein a second bump is provided on an outer side wall of the heat insulation member, and is configured to abut against the inner wall of the through hole after installing the smoking box into the smoking cavity to produce a gap between the through hole and a side wall of the smoking box.
